(19) United States
(12) Patent Application Publication
(10) Pub. No.: US 2011/0262143 A1
(43) Pub. Date: Oct. 27, 2011

(54) ROADM SYSTEMS AND METHODS OF OPERATION

(75) Inventors: Philip N. JI, Princeton, NJ (US); Yoshiaki AONO, Chiba (JP); Ting WANG, West Windsor, NJ (US)

(73) Assignee: NEC Laboratories America, Inc., Princeton, NJ (US)

(21) Appl. No.: 12/814,915

(22) Filed: Jun. 14, 2010

Related U.S. Application Data
(60) Provisional application No. 61/326,432, filed on Apr. 21, 2010.

(51) Int. Cl. H04J 14/02

(52) U.S. Cl. 398/83

(57) ABSTRACT

ROADM node systems and methods of operation are disclosed. ROADM node systems may include transponder aggregators including transponders to add signals for switching through the ROADM node. The transponder aggregators include optical couplers constrained that are from coupling added signals on adjacent channels for simultaneous use. The ROADM system may include an optical interleaver that can provide an additional filtering function for the coupled signals prior to transmission of the signals on a WDM network.

### RELATED APPLICATION INFORMATION

This application claims priority to provisional application Ser. No. 61/326,432 filed on Apr. 21, 2010, incorporated herein by reference.

### BACKGROUND

1. Technical Field

The present invention relates to reconfigurable optical add/drop multiplexer (ROADM) systems and methods of operation and, in particular, to managing added signals in an ROADM node.

This application is also related to commonly owned co-pending application Ser. No. 12/718,145 filed on Mar. 5, 2010 and commonly owned provisional application Ser. No. 61/250,185 filed on Oct. 9, 2009, each of which is incorporated herein by reference.

2. Description of the Related Art

A reconfigurable optical add/drop multiplexer (ROADM) node is an important optical network element that permits flexible adding and dropping of signals on any or all wavelength division multiplexing (WDM) channels at the wavelength layer. A multi-degree ROADM node (MD-ROADM), which can correspond to a ROADM node with 3 degrees or higher, is another optical network element that also provides a cross-connection function of WDM signals among different paths. Although conventional ROADM nodes have a certain degree of flexibility for adding and dropping signals on WDM channels, they do not possess sufficient flexibility to adapt to rapidly growing and increasingly dynamic Internet-based traffic. For example, transponders of conventional ROADM nodes typically do not have non-blocking and wavelength transparent access to all dense wavelength division multiplexing (DWDM) network ports. As a result, colorless and directionless (CL&DL) MD-ROADM nodes have been widely studied recently to replace conventional ROADM nodes. In this context, “colorless” can refer to ROADM nodes in which transponders can receive and transmit signals on any wavelength employed by the ROADM node system. In turn, “directionless” can refer to ROADM nodes in which transponders can receive signals originating from any input port and can forward signals to any output port.

Some current, proposed methods for building CL&DL MD-ROADM nodes suggest employing a large scale fiber switch, also referred to as a photonic cross-connect (PXC). For example, with reference to FIG. 1, according to these methods, a large scale fiber switch 102 can be implemented at the core of the ROADM node 100. Alternatively, with reference to FIG. 2, other methods suggest implementing large scale fiber switches 202 and 204 between transponders 206 and the multiplexers 208 in the ROADM node 200.

### SUMMARY

The CL&DL MD-ROADM nodes described above incur significant expense due to the high cost of using large port-count fiber switches. Moreover, the architecture illustrated in FIG. 1 also presents a large single point of failure in the node and is thus undesirable. In contrast, exemplary implementations of the present invention described herein below provide a low-cost ROADM node system and method of operation that can facilitate flexible add/drop capabilities while maintaining a low crosstalk level between channels. In particular, a significant advantage provided by exemplary embodiments of the present inventions is that an ROADM node can utilize the full, available spectrum for transmission of signals on a WDM network despite the use of an inter-channel crosstalk mitigation scheme for internal switching purposes.

One exemplary embodiment of the present invention is directed to a method for managing signals in a WDM network implemented in an ROADM node. In accordance with the method, signals may be added on pre-defined channels via a plurality of transponders within a transponder aggregator. The added signals on a first subset of the pre-defined channels can be coupled for switching in the ROADM node with a constraint that signals on adjacent channels are not coupled. In addition, the added signals on a second subset of the pre-defined channels can be coupled for switching in the ROADM node such that the second subset of the pre-defined channels includes at least one channel that is adjacent to a channel in the first subset of the pre-defined channels. Thereafter, the signals on the corresponding subsets of channels can be transmitted.

Another exemplary embodiment of the present invention is drawn towards an ROADM node system for managing signals in a WDM network. The system may comprise a plurality of transponder aggregators including a plurality of transponders configured to add signals on pre-defined channels. The system may further include a first optical coupler configured to couple the added signals on a first subset of the pre-defined channels for switching in the ROADM node such that the coupling is constrained from coupling added signals on adjacent, pre-defined channels. In addition, the system may also comprise a second optical coupler configured to couple the added signals on a second subset of the pre-defined channels for switching in the ROADM node such that the second subset of the pre-defined channels includes at least one channel that is adjacent to a channel in the first subset of the pre-defined channels.

An alternative exemplary embodiment of the present invention is directed to a transponder aggregator system for use in an ROADM node for managing signals in a WDM network. The system may comprise a plurality of transponders configured to add signals on pre-defined channels. The system may further include a first optical coupler configured to couple the added signals on a first subset of the pre-defined channels for switching in the ROADM node such that the coupling is constrained from coupling added signals on adjacent, pre-defined channels. In addition, the system may also comprise a second optical coupler configured to couple the added signals on a second subset of the pre-defined channels for switching in the ROADM node such that the second subset of the pre-defined channels includes at least one channel that is adjacent to a channel in the first subset of the pre-defined channels. The system may further include an optical interleaver that is configured to interleave added signals on the first and second subsets of channels prior to transmission on the network such that the interleaved signals include signals on adjacent channels.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is an exemplary MD-ROADM system that utilizes a large scale fiber switch.

FIG. 2 is an alternative exemplary MD-ROADM system that utilizes a large scale fiber switch.

FIG. 3A is a graph illustrating the crosstalk between channels exhibited by an MD-ROADM system that employs an optical multiplexer for channels including added signals.

FIG. 3B is a graph illustrating the crosstalk between channels exhibited by an MD-ROADM system that does not employ an optical multiplexer for channels including added signals.

FIG. 4 is a block/flow diagram of an exemplary system/apparatus embodiment of an ROADM node.

FIG. 5A is a graph illustrating the channel crosstalk exhibited by signals output from an odd channel coupler according to an exemplary embodiment of the present invention.

FIG. 5B is a graph illustrating the channel crosstalk exhibited by signals output from an even channel coupler according to an exemplary embodiment of the present invention.

FIG. 6 is a graph illustrating a spectra of both odd and even paths of an optical interleaver according to an exemplary embodiment of the present invention.

FIG. 7 is a graph illustrating a filtering function provided by an optical interleaver on channels including coupled signals received from an odd channel coupler and an even channel coupler in an exemplary ROADM node embodiment.

FIG. 8 is a flow diagram of an exemplary method for managing signals in a WDM network.

### DETAILED DESCRIPTION OF PREFERRED EMBODIMENTS

Prior to describing exemplary embodiments of the present invention in detail, it is important to note that, because CL&DL MD-ROADM nodes permit flexible wavelength assignment, optical multiplexers that were commonly used in the conventional ROADM nodes can typically no longer be employed. In lieu of optical multiplexers, optical couplers can be used in transponder aggregators to combine added signals on channels received from local transponders. However, such “multiplexer-less” architectures have a drawback in optical performance.

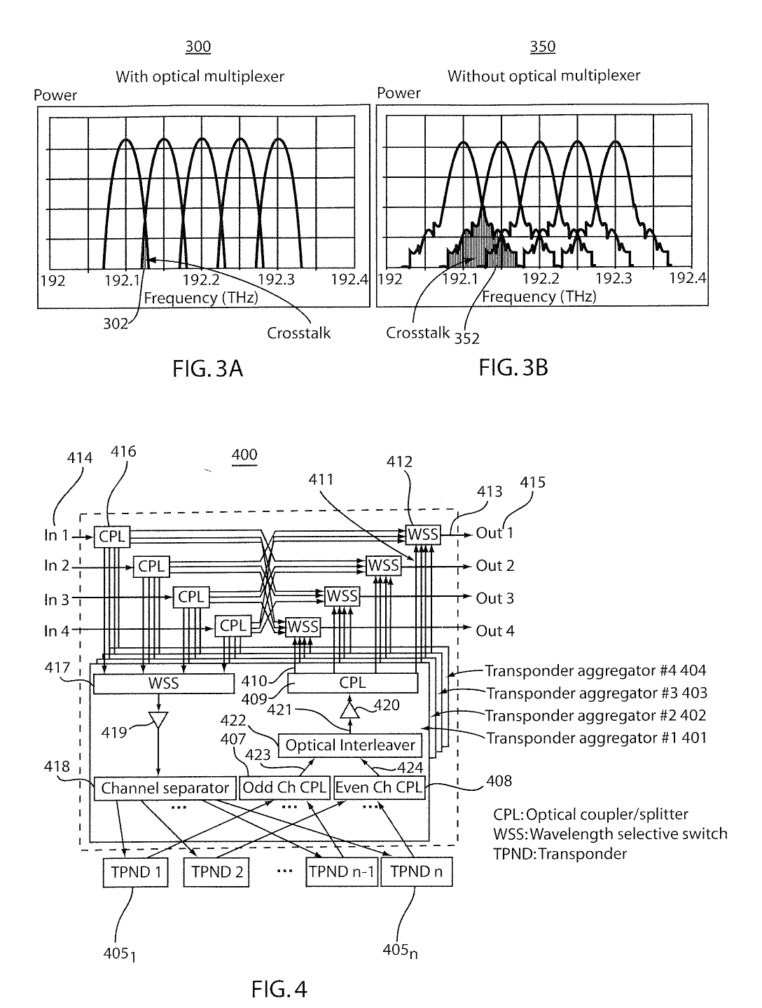

For example, the absence of the multiplexer leads to inter-channel crosstalk among different DWDM channels, and, in particular, between the adjacent channels. In general, as the transmission bit rate increases, the signal spectrum widens and the inter-channel crosstalk becomes more severe. FIGS. 3A and 3B illustrate the incidence of crosstalk that results after removing an optical multiplexer for 128 Gb/s PDM-NRZ-QPSK (polarization division multiplexed-non-return to zero-quadrature phase shift keying) signals over a 50 GHz-spaced DWDM system in a conventional ROADM node. For example, FIG. 3A is a plot 300 of power v. frequency of an output of a conventional ROADM node with an optical multiplexer, while FIG. 3B is a plot 350 of power v. frequency of an output of a conventional ROADM node without an optical multiplexer. As illustrated in FIGS. 3A and 3B, the crosstalk 352 of outputs of a conventional ROADM node without an optical multiplexer is significantly larger than the crosstalk 302 of outputs of a conventional ROADM node with an optical multiplexer.

To mitigate the crosstalk problem, the optical couplers used in transponder aggregators to combine added signals from local transponders can be replaced with a wavelength selective switch (WSS). While this may eliminate the crosstalk issue, the solution is also costly due to the requirement of an additional WSS in each transponder aggregator. Moreover, the WSS port count is limited. For example, common commercially available WSS devices have a 9×1 configuration. An alternative way to mitigate the crosstalk problem is to provide a tunable filter at the output of each local transponder. However, this also increases hardware cost significantly. For example, for a four degree node on a 96 channel DWDM system, the solution would require 384 optical tunable filters. Furthermore, the solution increases hardware size, system reconfiguration time, power consumption and control complexity.

With reference now to FIG. 4, an MD-ROADM node 400 in accordance with an exemplary embodiment of the present invention is illustrated. The exemplary node 400 includes input ports 414 and output ports 415. It should be understood that “CPL” refers to an optical coupler/splitter. As illustrated in FIG. 4, each input is associated with a splitter 416 that splits input signals and provides them to wavelength selective switches 412. Each wavelength selective switch (WSS) 412 is associated with a different output port 415. The splitter 416 can also provide its input signal to each WSS 417 in each transponder aggregator. For an N degree node (having N input ports and N output ports), there are N transponder aggregators to provide colorless and directionless add/drop functions. Accordingly, the exemplary ROADM node 400 includes four transponder aggregators 401-404, as the node has four input ports and four output ports. Each WSS 417 provides a drop signal selection function and can transmit selected channels from all input ports to the channel separator 418, which in turn, separates the selected channels for input to n transponders, 405₁-405ₙ in the corresponding aggregator. Here, the signals on the selected channels are transmitted by the corresponding transponders to various clients (not shown). For example, the transponders (on the ‘WDM side’ or ‘line side’) may convert the dropped optical signals to electrical signals for transmission to a client (on the ‘client side’). In turn, the client may provide the transponder with other data that the transponder adds on optical channels for subsequent transmission on the WDM network. For example, the transponder may receive client data in the form of electrical signals and may convert them to optical signals. Typically, the transponders 405₁-405ₙ add the client data to the same channel it receives from the channel selector 418. In other words, the transponders add client data to channels on which dropped signals are received. However, any one or more of the transponders 405₁-405ₚ can be tunable such that the client data can be added to any available channel, different from the channel it receives that includes dropped signals, as long as the channel selected to add the client data is not employed elsewhere, for example, in the transponder aggregator and/or in the ROADM node.

It should be noted that n is the number of channels selected by WSS 417 in one particular instance. Each transponder aggregator may have additional transponders. Furthermore, in this exemplary embodiment, the transponders 405₁-405ₙ can add signals on DWDM channels for switching through the ROADM node and subsequent transport to the WDM network through one or more output ports 415. Signals from transponders 405₁-405ₙ may be provided to couplers 407 and 408, as discussed further herein below, which, in turn, couple their received signals and provide the coupled signals to an optical interleaver 422. As discussed further herein below, the optical interleaver can interleave signals received from couplers 407 and 408 and can provide the interleaved signals to a splitter 409. The splitter 409 splits its received signals and can provide the signals to each WSS 412 of each output port 415. The WSS 412 selects channels/signals for output on its corresponding port. In addition, it should also be noted that each of the transponder aggregators may include optical amplifiers 419 and 420 between the WSS 417 and the channel separator 418 and between the optical interleaver 422 and splitter 409, respectively. Furthermore, the transponder aggregators 402-404 can have the same components and configuration as that shown for transponder aggregator 401 in FIG. 4. Moreover, although the WSS 417, optical couplers 407 and 408, the optical interleaver 422 and the optical splitter 409 are shown as being included in the transponder aggregator, in alternative embodiments, any one or more of these components may be external to transporter aggregators.

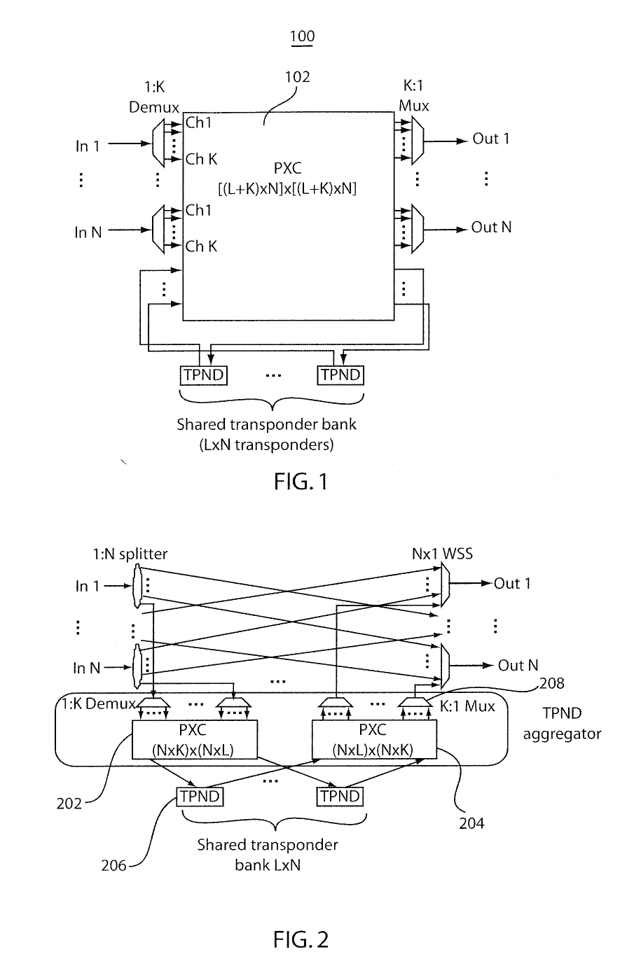

As discussed further herein below, the exemplary ROADM node 400 constrains couplers from coupling signals on adjacent channels added by transponders to avoid adjacent channel crosstalk, while at the same time enables the use of the full spectrum of available channels for output from the ROADM node and transmission on the WDM network. In the particular embodiment described herein below, separate couplers are used for odd channels and even channels to mitigate inter-channel crosstalk. Further, the exemplary ROADM node 400 uses a passive optical interleaver to mitigate the remaining inter-channel crosstalk within each transponder aggregator. The system 400 also maintains CL&DL features. As a result, the ROADM node 400 and its method of operation provide significant advantages over existing systems. For example, compared with most common colorless and directionless MD-ROADM architectures that use an optical coupler to combine added signals, the ROADM node system 400 and its method of operation can improve the transmission performance by reducing the inter-channel optical crosstalk, while at the same time permitting the use any of the available channels for transmission on the network. This improvement can enable longer transmission distance and a better optical power budget. In addition, in comparison to MD-ROADM architectures shown in FIGS. 1 and 2, exemplary embodiments of the present invention significantly reduce hardware costs, as they enable the use of smaller hardware size and lower power consumption, and also avoid large single points of failures in the node. It should also be noted that the number of transponder aggregators employed by exemplary embodiments of the present invention, such as system/apparatus 400, need not in any way be dependent on an add/drop percentage of signals switched through the ROADM node. Furthermore, exemplary embodiments need not require the use of a wavelength assignment scheme. However, wavelength assignment schemes may optionally be employed or added in other embodiments.

According to exemplary aspects of the present invention, one or more of the transponder aggregators 401-404 may each include two optical couplers 407 and 408 to couple signals added by subsets of the transponders 405₁-405ₙ. For example, coupler 407 can combine only odd DWDM channels from the transponders and is referred to as an “odd channel coupler.” In turn, coupler 408 can be used to combine only the even DWDM channels from the transponders and is referred to as an “even channel coupler.” Although the DWDM channel sets that the couplers 407 and 408 combine are different, both of the couplers can be the same passive optical device. For example, each coupler 407 and 408 can have ┌n/2┐ input ports and one output port, where n is the maximum total number of transponders in the corresponding transponder aggregator. The optical interleaver 422 in system 400 combines the outputs from these two couplers 407 and 408. The output of the odd channel coupler 407 is connected to the odd channel input of the interleaver 422, while the output of the even channel coupler 408 is connected to the even channel input of the interleaver 422. Here, the output of the interleaver has the same free spectral range (FSR) as the DWDM channel spacing.

In operation, the transponders with odd channel outputs, such as transponders 105₁, 105₃, 105₅, . . . 105ₙ₋₁, are connected to the odd channel coupler 407. Their output wavelengths can be flexibly tuned to any available wavelength, as noted above, but are constrained to be odd channels in this exemplary embodiment. In turn, the transponders with even channel outputs, such as transponders 105₂, 105₄, 105₆, . . . 105ₙ, are connected to the even channel coupler 408. Similarly, output wavelengths of the even transponders can flexibly be tuned to any available wavelength flexibly, but are constrained to be on even channels in this embodiment.

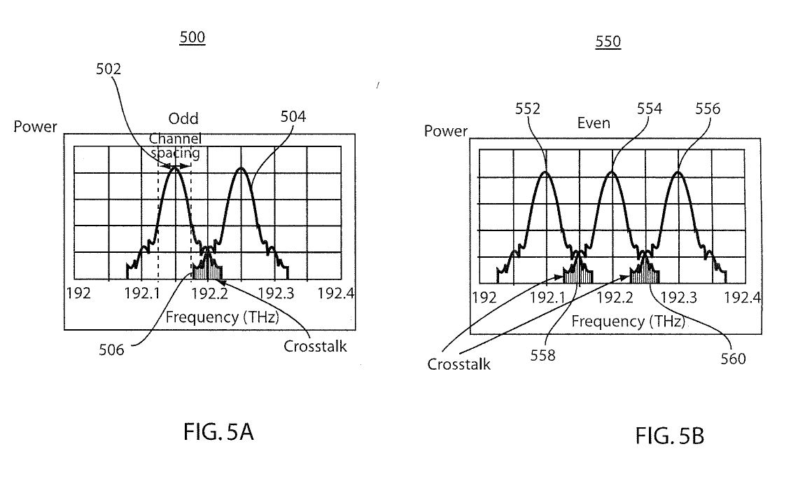

FIG. 5A illustrates an optical signal spectrum example at the output 423 of the odd channel coupler 407. Because the spectrum includes only odd channels and does not include any even channel, there is at least one channel gap between any two channels on which data is added by the transponders, as shown in plot 500 in FIG. 5A, illustrating a one-channel channel gap between channels 502 and 504. Similarly, for the coupled signals 424 output from the even coupler 408, there is also at least one channel gap between any two channels on which data is added. For example, as shown in plot 550 of FIG. 5B, there is a one channel gap between channels 552 and 554 and between channels 554 and 556. Furthermore, FIGS. 5A and 5B illustrate that that any resulting crosstalk 506, 558 and 560 between channels is much lower than the crosstalk exhibited in a convention ROADM node without an optical multiplexer, as indicated by comparison with plot 350 of FIG. 3B. The mitigation of crosstalk in exemplary embodiments of the present invention is due to the constraint that adjacent DWDM channels are not permitted to be coupled in the transponder aggregator and, as a result, no or nominal adjacent channel crosstalk, which is defined as the crosstalk from the next channel on the standard transmission grid, occurs. In addition, whatever crosstalk that does occur is mainly at the rejected band, which is outside the clear channel passband defined by the channel spacing; any crosstalk in the signal passband is very small (beyond the range of the spectra here).

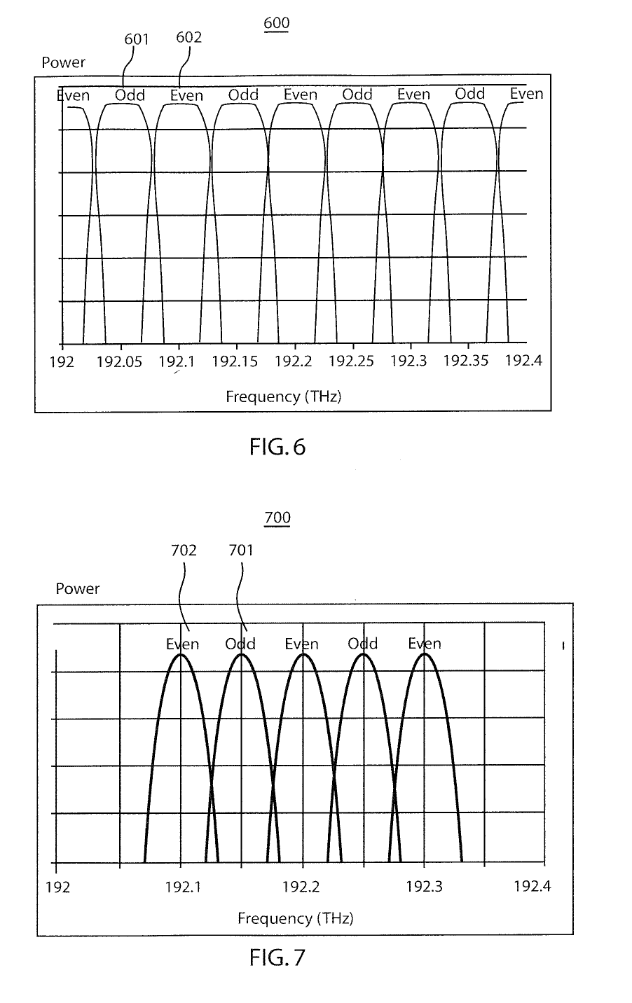

With reference now to FIG. 6, a graph 600 illustrating the spectra of both odd and even paths of the optical interleaver 422 is provided. Here, the odd input port of the interleaver 422 is configured to reject or filter out signals or noise on even channels 602 received from the odd channel coupler at its odd channel input. Similarly, the even input port of the interleaver 422 is also configured to reject or filter out signals or noise on odd channels 601 received from the even channel coupler at its even channel input. In this way, the interleaver 422 can be employed as a filter to further mitigate any crosstalk between channels, such as crosstalk 506, 558 and 560 in FIGS. 5A and 5B exhibited between odd channels and between even channels. As such, after the combined odd and even channels, 423 and 424, respectively, pass through the optical interleaver 422, the output 421 can have the exemplary spectrum shown in graph 700 and can include all channels on which signals are added by transponders 405₁-405ₙ, including odd channels 701 and even channels 702. Essentially the crosstalk is minimized to the same level as using an optical multiplexer, as shown in FIG. 3A, or even lower, as optical interleavers can have a wider flat-top profile and steeper passband edges.

Retuning to FIG. 4, the combined signals 421 are split through an optical splitter 409 and can be sent to the WSSs at all output ports. The signals 410-411 reaching the WSSs all have the same profile and crosstalk characteristics as the signals 421. Among these channels, each WSS 412 selects the appropriate channels 413 to be sent to its corresponding output port 415. At the output 415 of each node, signals received from one or more transponder aggregators on their corresponding channels can be combined in the WSS 412. The resultant signals have the characteristics of the low crosstalk signals shown in FIG. 3A. Furthermore, the resultant signals can include any combination of channels, including signals from adjacent channels received from the transponder aggregators. Accordingly, even though an inter-channel cross-talk mitigation scheme has been applied for internal switching purposes, the ROADM node retains a substantial advantage in that it can fully utilize the available spectrum for transmission of signals on the WDM network. Moreover, ROADM nodes 400 maintains colorless and directionless features, as the transponders 405₁-405ₚ permit wavelength tuning (with odd/even constraints) and each channel from these transponders can be switched to any output port. The WSS 412 at the output end also eliminates the wavelength contention issue.

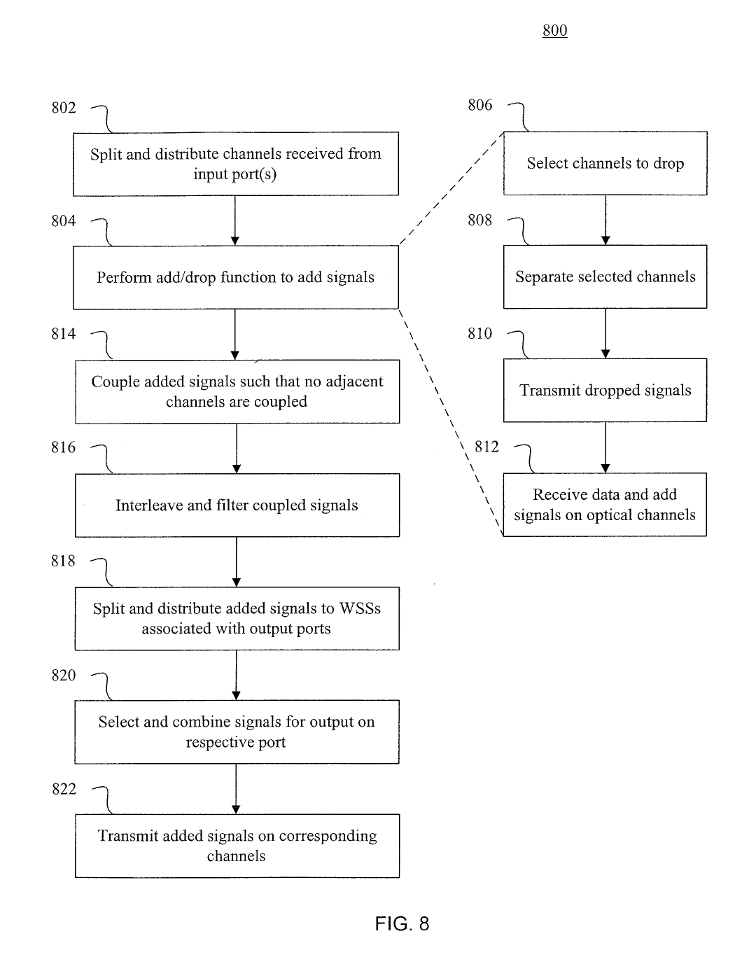

With reference now to FIG. 8 with continuing reference to FIG. 4, a block/flow diagram of a method 800 for managing signals in a WDM network implemented in accordance with exemplary embodiments of the present invention is provided. It should be understood that any one or more aspects of the ROADM node system/apparatus 400 described above can be included in method 800. Likewise, any one or more aspects of method 800 described herein below can be included in ROADM node system/apparatus 400. In addition, it should also be understood that not all steps described herein below are essential and alternative exemplary embodiments of the present invention may include other steps, may implement steps described herein below differently and/or may omit steps described herein below.

It should be noted that the channels employed by an ROADM node system that implements method 800 may correspond to DWDM channels of a standard grid, as discussed above with respect to FIG. 4. Thus, the channels employed may be pre-defined and may have consistent channel spacing. For example, as illustrated in 3B, the channels may be pre-defined with a channel spacing of 0.05 THz, where 192.10 THz, 192.15 THz, 192.20 THz, 192.25 THz, etc. are included in the set of pre-defined channels employed by the system. Further, the ROADM node can be preconfigured to employ the set of pre-defined channels for switching and/or for downstream and/or upstream transmission of signals on a WDM network.

At step 802, channels received from input ports may be split and distributed. For example, any one or more splitters 416 can be configured to perform step 802. For example, as discussed above with respect to FIG. 4, any one or more splitters 416 can split signals received from an input port 414 for distribution to WSSs 412 as well as WSSs 417 in the various transponder aggregators. One or more of the transponder aggregators can receive the same signals or at least some of the signals received by the transponder aggregators can be the same signals.

At step 804, an add/drop function may be performed. For example, step 804 may be implemented via steps 806-812. It should be noted that step 806, as well as steps 814 and 816, can be performed by one or more of the transponder aggregators 401-404.

At step 806, an element may select channels to drop. For example, as discussed above with respect to FIG. 4, each of the WSSs 417 can select signals on corresponding channels to drop and to provide to their corresponding transponders 405₁-405ₙ. In turn, the selected channels may be separated at step 808. For example, channel separator 418 may be configured to separate channels for the signals dropped by WSS 417.

At step 810, the dropped signals may be transmitted. For example, as discussed above with regard to FIG. 4, any one or more of the transponders 405₁-405ₙ may convert the dropped signals to electrical signals and may transmit the converted signals to one or more clients.

At step 812, data may be received and signals may be added on the pre-defined set of channels. For example, as discussed above with regard to FIG. 4, the transponders 405₁-405ₙ of each transponder aggregator 401-404 can receive data from clients in the form of electrical signals and can convert the signals to optical signals. Moreover, as discussed above with respect to FIG. 4, each transponder 405₁-405ₙ can add signals on the channel on which dropped signals are received or can add signals on a channel that is different from the channel on which dropped signals are received, as long as the channel used is not employed elsewhere, for example, in the transponder aggregator or the ROADM node.

At step 814, added signals may be coupled such that no adjacent channels are coupled. For example, the optical coupler 407 and the optical coupler 408 can separately perform step 814. Using the pre-defined channels indicated in FIGS. 5A and 5B as an example, both the odd channel coupler 407 and the even channel coupler 408 are constrained from coupling signals on both channels 192.15 THz and 192.20 THz. In addition, here, the channels coupled by the odd channel coupler 407 and the channels coupled by the even channel coupler 408 can be mutually exclusive. For example, again using the pre-defined channels indicated in FIGS. 5A and 5B, an odd channel coupler 407 may be configured to couple signals on only channels within the set 192.15 THz, 192.25, 192.35, etc., while an even channel coupler 408 may be configured to couple signals on only channels within the set 192.10 THz, 192.20, 192.30, etc. Of course, the channel spacing and band employed can be varied.

It should be understood that although “odd” and “even” channel couplers were used as examples above, in accordance with other exemplary embodiments, the channel couplers are constrained from coupling certain channels only at certain moments in time. For example, at one moment in time, a channel coupler may couple signals on channel 192.2 THz with other signals and is constrained from coupling signals on channels 192.15 THz and 192.25 THz with the signals on channel 192.2 THz at that moment in time. At another moment in time, that same optical coupler may couple signals on channel 192.25 THz with other signals and is constrained from coupling signals on channels 192.20 THz and 192.30 THz with signals on channel 192.25 THz. Thus, according to exemplary aspects, one or more optical couplers can be constrained from coupling signals on adjacent channels for simultaneous use. It should be noted that the phrase “for simultaneous use” is not intended to exclude odd and even channel coupler embodiments discussed above. For example, odd and even channel couplers discussed above are also constrained from coupling signals on adjacent channels for simultaneous use, as no adjacent channels are simultaneously coupled in the odd and even channel couplers.

Furthermore, it should also be noted that not all couplers need be constrained. For example, certain couplers within a transponder aggregator or within an ROADM node may be configured to couple all available channels simultaneously while other optical couplers may be configured to be constrained from coupling adjacent pre-defined channels for simultaneous use, as discussed above. In addition, different constrained optical couplers need not be assigned to exclusively odd or even channels. For example, different couplers may be assigned a portion of odd channels and a portion of even channels on which signals may be coupled while being constrained from coupling signals on adjacent channels from the pre-defined channels. Furthermore, channel couplers of different transponder aggregators may be configured in the same manner or may be configured differently. Thus, different configurations and ways of constraining one or more optical couplers from coupling added signals on adjacent channels are envisioned and are included in various exemplary embodiments of the present invention.

At step 816, the coupled signals may be interleaved and filtered. For example, as discussed above, optical interleaver 422 may interleave signals received from optical couplers 407 and 408 such that the interleaved signals 421 include adjacent channels and may provide the interleaved signals 421 to the optical splitter 409 for switching through the ROADM node. In addition, as stated above, the interleaver 422 may provide a filtering function that can further reduce crosstalk. For example, any one or more of the interleavers 412 can be configured to reject or filter out channels based on the origin of added signals. For example, for the signals received from an odd optical coupler 407, the interleaver 422 can be configured to filter out even channels and thereby further reduce crosstalk. Similarly, for the signals received from an even optical coupler 408, the interleaver 422 can be configured to filter out odd channels to further reduce crosstalk. For example, the interleaver 422 can be configured to filter out even channels received from the port on which signals are received from the odd coupler 407. In addition, the interleaver 422 can be configured to filter out odd channels received from the port on which signals are received from the even coupler 408. However, as discussed above, different configurations and ways of constraining one or more optical couplers from coupling added signals on adjacent channels are envisioned. Thus, the interleaver 422 can be configured to filter out any channel from an optical coupler that the optical coupler is constrained from coupling. For example, if the optical coupler is dynamically constrained from coupling certain channels from moment to moment, the interleaver 422 can dynamically filter those channels.

At step 818, the added signals may be split and distributed to WSSs associated with output ports. For example, as discussed above with respect to FIG. 4, the splitter 409 may split interleaved signals on corresponding channels received from the optical interleaver 422 and may distribute the signals to the various WSSs 412 associated with output ports 415.

At step 820, channels may be selected and corresponding signals can be combined for output on a respective port. For example, as discussed above with respect to FIG. 4, one or more WSSs 412 may receive added signals from any one or more of the transponder aggregators 401-404 and may select and combine the signals received from one or more of the different aggregators with each other and/or with signals received from one or more couplers 416 for output. As discussed above, WSSs 412 can combine WDM channels received from the transponder aggregators, which can include adjacent channels. As such, the output on ports 415 may include adjacent channels from the pre-defined channels. Thus, any of the odd channels can be transmitted simultaneously from the ROADM node with any of the even channels via one or more output ports 415, thereby permitting the ROADM node to fully utilize the available spectrum even though an “odd” or “even” constraint was used for internal switching. Moreover, as discussed above, because each channel on which signals are added by the transponders can be switched to any output port, the ROADM node can maintain colorless and directionless features.

At step 822, the signals can be transmitted on their corresponding channels. For example, the signals combined by WSSs 412 can be output from the corresponding output ports 415.

It should be noted that, in accordance with the exemplary ROADM node system/apparatus embodiment 400 described above with regard to FIG. 4, even though optical couplers are used at the transponder aggregators in lieu of an optical multiplexer, the inter-channel crosstalk, and, in particular, adjacent channel crosstalk, of the added signals is reduced to approximately the same level (or less) as inter-channel crosstalk exhibited in ROADM nodes using optical multiplexers for the added signals. Moreover, wavelength coupling constraints discussed above ensure that no adjacent channel crosstalk will occur within the transponder aggregator. In addition, as discussed above, the optical interleavers can be utilized to further reduce the crosstalk from other channels. One significant advantage of aspects of the present principles is that although an inter-channel cross-talk mitigation scheme has been applied for internal switching purposes, the ROADM node is nonetheless capable of fully utilizing the available spectrum for transmission on the WDM network. These benefits can be achieved without additional costly hardware such as a large scale fiber switch or high port count WSSs.

It should be understood that embodiments described herein may be composed entirely of hardware elements or both hardware and software elements. In a preferred embodiment, the present invention is implemented in hardware and software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores the program for use by or in connection with the instruction execution system, apparatus, or device. The medium can be magnetic, optical, electronic, or semiconductor system (or apparatus or device). The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/0 devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for managing signals in a wavelength-division multiplexing (WDM) network implemented in a reconfigurable optical add-drop multiplexer (ROADM) node comprising:
adding signals on pre-defined channels via a plurality of transponders within a transponder aggregator;
coupling the added signals on a first subset of the pre-defined channels for switching in the ROADM node such that the coupling is constrained from coupling signals on adjacent channels;
coupling the added signals on a second subset of the pre-defined channels for switching in the ROADM node such that the second subset of the pre-defined channels includes at least one channel that is adjacent to a channel in the first subset of the pre-defined channels; and
transmitting the signals on the corresponding subsets of channels.

2. The method of claim 1, further comprising
combining at least a subset of the added signals such that the combined signals include signals on adjacent channels, wherein the transmitting includes transmitting the combined signals.

3. The method of claim 1, wherein the coupling the added signals on the second subset of the added channels is constrained from coupling signals on adjacent channels.

4. The method of claim 1, wherein the first and second subsets of the pre-defined channels are mutually exclusive channels.

5. The method of claim 1, further comprising:
interleaving the added signals on the first and second subsets of channels prior to transmission on the network such that the interleaved signals include signals on adjacent channels.

6. The method of claim 5, wherein the coupling the added signals on a first subset of the pre-defined channels is performed in a coupler and wherein the interleaving further comprises filtering signals from the coupler such that channels on which the coupler is constrained from coupling are filtered.

7. The method of claim 1, wherein the transponders add signals on dense wavelength division multiplexing (DWDM) signals.

8. The method of claim 6, wherein the transponders have colorless access to the pre-defined channels.

9. The method of claim 6, wherein the transponders have directionless access to output ports of the ROADM node.

10. A reconfigurable optical add-drop multiplexer (ROADM) node system for managing signals in a wavelength-division multiplexing (WDM) network comprising:
a plurality of transponder aggregators, wherein each transponder aggregator comprises:
a plurality of transponders configured to add signals on pre-defined channels;
a first optical coupler configured to couple the added signals on a first subset of the pre-defined channels for switching in the ROADM node such that the coupling is constrained from coupling added signals on adjacent, pre-defined channels; and
a second optical coupler configured to couple the added signals on a second subset of the pre-defined channels for switching in the ROADM node such that the second subset of the pre-defined channels includes at least one channel that is adjacent to a channel in the first subset of the pre-defined channels.

11. The system of claim 10, further comprising:
a plurality of wavelength selective switches (WSSs), wherein each wavelength selective switch (WSS) of the plurality of WSSs is associated with a different output port and is configured to combine signals received from at least a subset of the plurality of transponder aggregators, wherein the combined signals are transmitted from the ROADM node and include signals on adjacent channels of the pre-defined channels.

12. The system of claim 10, wherein the second optical coupler is constrained from coupling added signals on adjacent channels.

13. The system of claim 10, wherein the first and second subsets of the pre-defined channels are mutually exclusive channels.

14. The system of claim 10, wherein each transponder aggregator further includes
an optical interleaver configured to interleave added signals on the first and second subsets of channels prior to transmission on the network such that the interleaved signals include signals on adjacent channels.

15. The system of claim 14, the interleaver is further configured to filter signals from the first optical coupler such that channels on which the first optical coupler is constrained from coupling are filtered.

16. The system of claim 14, wherein the transponders add signals on dense wavelength division multiplexing (DWDM) signals.

17. The system of claim 16, wherein the optical interleaver has the same free spectral range as DWDM channel spacing.

18. The system of claim 10, wherein the transponders have colorless access to the pre-defined channels.

19. The system of claim 10, wherein the transponders have directionless access to output ports of the ROADM node.

20. A transponder aggregator system for use in a reconfigurable optical add-drop multiplexer (ROADM) node for managing signals in a wavelength-division multiplexing (WDM) network comprising:
a plurality of transponders configured to add signals on pre-defined channels;
a first optical coupler configured to couple the added signals on a first subset of the pre-defined channels for switching in the ROADM node such that the coupling is constrained from coupling added signals on adjacent, pre-defined channels;
a second optical coupler configured to couple the added signals on a second subset of the pre-defined channels for switching in the ROADM node such that the second subset of the pre-defined channels includes at least one channel that is adjacent to a channel in the first subset of the pre-defined channels; and
an optical interleaver configured to interleave added signals on the first and second subsets of channels prior to transmission on the network such that the interleaved signals include signals on adjacent channels.
